(19) United States
(12) Patent Application Publication
(10) Pub. No.: US 2009/0005533 A1
(43) Pub. Date: Jan. 1, 2009

(54) Method for Producing Polyether Alcohols

(75) Inventors: Stefan Dinsch, Schipkau (DE); Jurgen Winkler, Schwarzheide (DE); Gerd Hoppner, Schwarzheide (DE); Holger Seifert, Bohmte (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/910,936

(22) PCT Filed: Apr. 5, 2006
(86) PCT No.: PCT/EP2006/061351

§ 371 Date: Oct. 8, 2007

(30) Foreign Application Priority Data
Apr. 6, 2005 (DE) 10 2005 015 894.3

(51) Int. Cl. C08G 65/26

(52) U.S. Cl. 528/405; 536/126

(57) ABSTRACT

The invention relates to a process for preparing polyether alcohols by catalytic addition of alkylene oxides onto a starter substance mixture comprising water-soluble H-functional starter substances which are solid at room temperature, alcohols which are liquid at the reaction temperature and water using alkali metal hydroxides and/or alkaline earth metal hydroxides as catalysts, wherein the amount of water is from 1.0 to 6.0% by weight, based on the weight of the starter substance mixture, and the starter substance mixture comprises no amine constituents.

The invention relates to a process for preparing polyether alcohols by catalyzed addition of alkylene oxides onto solid starter substances, primarily sucrose, and the use of these polyether alcohols for producing polyurethanes (PUR), in particular PUR foams.

The preparation of polyether alcohols by anionic polymerization of alkylene oxides has been known for a long time.

Further details on this subject may be found, for example, in Kunststoffhandbuch, Volume VII, Polyurethane, Carl-Hanser-Verlag, Munich, 1^{st} edition 1966, edited by Dr. R. Vieweg and Dr. A. Höchtlen, and also 2^{nd} edition 1983 and 3^{rd} edition 1993, edited by Dr. G. Oertel.

The use of, for example, monosaccharides, disaccharides or polysaccharides and further high-functionality compounds as starter substances for the synthesis of high-functionality polyether alcohols is known and has been described many times, in particular for the preparation of polyether alcohols which are intended for use in rigid PUR foams. Alkoxylations of these compounds in admixture with liquid costarters such as diols, triols or amines are customary. Depending on the proportion of this costarter, a more or less high functionality of the polyether alcohol is obtained.

To achieve a high network density in rigid polyurethane foams, polyether alcohols having high functionalities can be used. This requires starter substances having a large number of hydroxyl groups per molecule. The increase in the network density in the foam enables mechanical properties of the foam to be influenced and optimized. The formation of highly crosslinked structures leads to quicker buildup of stable foams and thus to the acceleration and improvement of the curing behavior in the system. The readily available sucrose in particular is among the substances which can form the basis of high-functionality polyether alcohols.

A process for the alkoxylation of solid starter substances is described in U.S. Pat. No. 3,346,557. Here, the starter substance comprising from 3 to 8 hydroxyl groups/mol is mixed with an amine catalyst and reacted in an adduct comprising a compound which is solid under the reaction conditions and comprises from 3 to 8 hydroxyl groups/mol with from 0.5 to 1.5 mol of a vicinal alkylene oxide. For example, sucrose, tributylamine and distilled water are mixed and reacted with propylene oxide. This adduct is stripped, mixed with tributylamine and propoxylated further. The addition product of sucrose and propylene oxide serves as reaction medium for the uptake of further sucrose for reaction with alkylene oxides. In this process, there is a risk of dark product colors, which are undesirable for some applications, being obtained as a result of the increased thermal stress on the intermediate. At the same time, this process requires renewed use of alkaline products or finished polyols. This impairs the process effectiveness.

DD 211797 describes a process for the stepwise preparation of polyether alcohols using solid or high-viscosity starter substances in combination with materials which have a combined function as catalyst and costarter, e.g. ammonia and/or its propoxylation products. Thus, for example, aqueous ammonia solution, aqueous potassium hydroxide solution and sucrose are mixed and propoxylated in a first reaction step. The product obtained is stripped and reacted with further propylene oxide. The incorporation of nitrogen-comprising compounds leads to a lower viscosity of the polyether alcohol and, as a result of the increased intrinsic reactivity, to a decrease in the curing performance in many applications.

The process described in DE-A-4209358 for preparing polyether alcohols based on solid and high-viscosity hydroxyl-, imine- or amine-functional starter substances comprises adding from 0.5 to 5% by weight, based on the polyol weight, of aliphatic amines to the starter substance or the starter substance mixture and subsequently reacting this with alkylene oxides. These polyols have low potassium contents and light colors. In this process, too, the amine content of the polyol causes an increased intrinsic reactivity toward isocyanates.

The preparation of high-functionality polyether alcohols based on sucrose and further, usually liquid, costarters is technologically difficult if the proportion of sucrose in the starter mixture exceeds 75% by weight and the solubility of sucrose in the costarters is low.

It has been found that polyether alcohols based on water-soluble solid H-functional starters, preferably sorbitol and/or sucrose, particularly preferably sucrose, in particular those having a high proportion of sucrose in the starter substance, frequently have a high proportion of unreacted sucrose. This can precipitate from the polyether alcohol and lead to sediments. Furthermore, the sucrose can lead to problems in the metering of the polyol component in the production of polyurethanes. In addition, the actual functionality of the polyether alcohols drops below the calculated functionality as a result.

As the functionality of the polyols increases, the proportion of sucrose relative to the proportions of the liquid or molten costarters in the starter mixture increases. The proportion of solid constituents in the starter mixture thus becomes so high that a series of disadvantages in terms of technology and product quality result. The unreacted sucrose alters the balance of quantities in the polyol and makes quality assurance in polyol production more difficult.

Thus, for example, mixing in the initial phase of the reaction becomes more difficult. Since the dissolution of sucrose in diols or triols is low and its solubility in their alkoxylates is lower still, there is a risk of, at a given hydroxyl number of, for example, >400, free crystalline sucrose being carried through the reaction and unreacted sucrose being present as sediment at the end of the alkoxylation.

To avoid problems in the processing of the polyether alcohols and the properties of the rigid foams, polyether alcohols based on solid starters, in particular sucrose, need to have no residual contents of unreacted solid starter.

It was an object of the invention to provide a process for preparing polyether alcohols based on solid starter substances, in particular sucrose, which gives polyether alcohols without residual unreacted solid starter substance, makes do without additional process steps and in which the customary starting compounds are used. The use of amines in the starter substance mixture should be dispensed with in order to avoid intrinsic reactivity of the polyether alcohols.

It has surprisingly been found that in the reaction of aqueous sorbitol or sucrose solutions with alkylene oxides, for example with propylene oxide, the reaction of the water starts with great difficulty and is thus significantly slower than the reaction with sorbitol, sucrose or diols and/or triols. For this reason, it is, surprisingly, possible to introduce a larger amount of water into the starter substance mixture than is required to achieve the target functionality without resulting in a significant increase in the glycol content in the polyether alcohol and thus an undesirable reduction in the functionality. Furthermore, it has been found that the solubility of the reaction product of sucrose with alkylene oxides in water is significantly lower than the solubility of sucrose in water, so that the water present in the reaction mixture can dissolve further sucrose present in the reaction mixture until the sucrose present in the reaction mixture has reacted completely. The water can then be removed from the reaction mixture. These effects can also be observed in the case of other water-soluble solid starter substances.

The invention accordingly provides a process for preparing polyether alcohols by catalytic addition of alkylene oxides onto a starter substance mixture comprising water-soluble H-functional starter substances which are solid at room temperature, in particular sorbitol and/or sucrose, particularly preferably sucrose, alcohols which are liquid at the reaction temperature and water using alkali metal hydroxides and/or alkaline earth metal hydroxides as catalysts, wherein the amount of water is from 1.0 to 6.0% by weight, based on the weight of the starter substance mixture, and the starter substance mixture comprises no amine constituents.

The invention further provides the polyether alcohols prepared by the process of the invention.

The amount of water in the starter substance mixture is preferably from 1.0 to 3.5% by weight, based on the weight of the starter substance mixture.

The functionality of the starter substance mixture without taking the water into account is preferably at least 4.5, particularly preferably 5 and in particular 6.5.

In a particularly preferred embodiment of the process of the invention, the water content of the reaction mixture is reduced to less than 1% by weight, based on the weight of the starter substance mixture, after addition of from 2 to 6 mol, in particular from 4 to 6 mol, of alkylene oxide onto the starter substance mixture. In this mode of operation, it is possible to obtain polyether alcohols which have a particularly high functionality, preferably greater than 4.5, particularly preferably 5.0 and in particular 6.5, and a very low content of free starter substance, in particular sucrose.

Solid starter substances used are, as described, in particular sugars, preferably sorbitol and/or sucrose and particularly preferably sucrose.

As alcohols which are liquid at the reaction temperature, also referred to as costarters, preference is given to using bifunctional to trifunctional alcohols. Examples are glycerol, diglycerol, trimethylolpropane and glycols such as ethylene glycol, diethylene glycol, triethylene glycol, propylene glycol, dipropylene glycol, tripropylene glycol, or butanediols either individually or as any mixture of at least two of the polyols mentioned. Particular preference is given to using glycerol and/or trimethylolpropane.

The choice of costarter for sucrose can be made according to economic points of view, but also according to the required intrinsic reactivity of the polyether alcohol or according to the solubility of the blowing agent used in the polyether alcohol.

Thus, when glycerol and/or trimethylolpropane is used as costarter, the solubility of cyclopentane, which is a blowing agent frequently used for producing rigid PUR foams, in the polyol is particularly good.

As alkylene oxides, preference is given to using ethylene oxide and/or propylene oxide, in particular propylene oxide alone.

Polyether alcohols having residual contents of solid starter of less than 0.1% by weight, preferably less than 0.08% by weight, based on the weight of the polyether alcohol, in particular less than 0.05% by weight, based on the weight of the polyether alcohol, can be obtained by means of the process of the invention.

In contrast, otherwise identical polyether alcohols whose starter mixtures have been dried have significantly higher contents of free sucrose after the synthesis, with the sucrose being present as a sediment in many cases.

Surprisingly, no appreciable reaction of the water with alkylene oxides to form glycols takes place in the process of the invention.

As described, it has surprisingly been found that the reaction of the alkylene oxides with water is significantly slowed compared to the other hydroxyl-bearing components of the starter substance. An appreciable reaction of water to form glycols occurs only when the amount of water is so high that the reaction of the alkylene oxide with the water takes place to a greater extent for statistical reasons, with the reaction then being shifted in the direction of glycol formation. However, this is not the case for the amount of water used according to the invention.

The formation of glycols by alkoxylation of water does occur even in the process of the invention. However, this is distinctly suppressed and has barely any adverse effect on the properties of the polyether alcohol.

This slight increase in the glycol content of the polyol together with a very slightly decreased functionality is more than made up for by the good solvent capability of the water for sucrose. It has been observed that an increased proportion of dissolved sucrose in the starter mixture improves the reaction of the sucrose with alkylene oxide and substantially reduces the content of free sucrose in the polyol.

Preference is given to using potassium hydroxide as basic catalyst. It is usually used in the form of the aqueous solution. This water is part of the amount of water used according to the invention.

The hydroxyl number of the polyether alcohols of the invention is preferably in the range from 300 to 600 mg KOH/g, in particular from 350 to 500 mg KOH/g.

Otherwise, the preparation of the polyether alcohols is carried out according to the customary and known processes.

One or more costarters and a defined amount of water are placed in the reactor, usually a stirred reactor with reactor heating and cooling, metering facilities for solid and liquid substances and alkylene oxides and also facilities for blanketing with nitrogen and a vacuum system, the desired amount of potassium hydroxide is metered in, the mixture is heated to 60-90° C., sucrose is added, the mixture is mixed well and heated to from 70 to 110° C.

The total amount of water is made up of the water in the potassium hydroxide solution, the water of reaction from the alkoxylation and the amount of water which is additionally added. It is, as described, from 1.0 to 6.0% by weight, based on the weight of the starter substance mixture. Propylene oxide is subsequently introduced. The reaction temperature rises to a value in the range from 105 to 115° C. during the reaction. The reaction is preferably followed by an after-reaction time to complete the reaction of the alkylene oxide. This after-reaction time is preferably from 2 to 5 hours.

The total amount of the alkylene oxides used can be introduced in succession in one step.

However, preference is given, as described, to initially adding from 2 to 6 mol, in particular from 4 to 6 mol, of alkylene oxide onto the starter substance, then reducing the water content of the prepolymer produced in this way to less than 1.0% by weight, based on the weight of the starter substance mixture, and then adding on the remaining alkylene oxide.

The prepolymer obtained in this way preferably has a hydroxyl number of from 650 to 820 mg KOH/g.

This prepolymer is reacted in a further step to give the finished polyether alcohol. For this purpose, the water content can, as described, be set to a value of less than 1% by weight, based on the weight of the prepolymer.

The prepolymer is then reacted with further propylene oxide at temperatures of from 105 to 118° C. until the desired hydroxyl number of from 300 to 600 mg KOH/g, in particular from 350 to 500 mg KOH/g, has been reached.

The polyether alcohol obtained in this way is worked up in a customary fashion. For this purpose, it is usually hydrolyzed with water, neutralised with mineral acid, filtered and stripped under reduced pressure.

The polyether alcohols prepared by the process of the invention are preferably used for producing rigid PUR foams. The production of the rigid PUR foams is carried out according to known methods by reacting polyisocyanates with compounds having at least two hydrogen atoms which are reactive toward isocyanate groups.

Possible organic polyisocyanates for the production of rigid PUR foams are preferably aromatic polyfunctional isocyanates. Preference is given to using diphenylmethane diisocyanate (MDI) and/or mixtures of diphenylmethane diisocyanate and polyphenylenepolymethylene polyisocyanates (crude MDI).

Further compounds having at least two hydrogen atoms which are reactive toward isocyanate groups can be used in admixture with the polyether alcohols prepared by the process of the invention. These are usually polyether alcohols. They usually have a functionality of preferably from 3 to 8 and hydroxyl numbers of preferably from 100 mg KOH/g to 600 mg KOH/g and in particular from 140 mg KOH/g to 480 mg KOH/g.

Compounds having at least two hydrogen atoms which are reactive toward isocyanate also include the chain extenders and crosslinkers which may, if appropriate, be used concomitantly. The addition of bifunctional chain extenders, trifunctional and higher-functional crosslinkers or, if appropriate, mixtures thereof can prove to be advantageous for modifying the mechanical properties. Chain extenders and/or crosslinkers used are, in particular, diols and/or triols having molecular weights of less than 400, preferably from 60 to 300.

The production of the rigid PUR foams is usually carried out in the presence of blowing agents, catalysts and cell stabilizers and, if necessary, further auxiliaries and/or additives.

As blowing agent, it is possible to use water which reacts with isocyanate groups to eliminate carbon dioxide. In combination with or in place of water, it is also possible to use physical blowing agents. These are compounds which are inert toward the starting components, are usually liquid at room temperature and vaporize under the conditions of the urethane reaction. The boiling point of these compounds is preferably below 50° C. Physical blowing agents also include compounds which are gaseous at room temperature and can be introduced into the starting components or dissolved in them under pressure, for example carbon dioxide, low-boiling alkanes, cycloalkanes and fluoroalkanes.

Furthermore, the production of the rigid foams is carried out in the presence of catalysts and, if necessary, further auxiliaries and/or additives. Catalysts used are, in particular, compounds which strongly accelerate the reaction of the isocyanate groups with the groups which are reactive toward isocyanate groups. Such catalysts are preferably strongly basic amines such as tertiary aliphatic amines, imidazoles, amidines and alkanolamines.

If isocyanurate groups are to be built into the rigid foam, special catalysts are required. As isocyanurate catalysts, use is usually made of metal carboxylates, in particular potassium acetate and solutions thereof.

The rigid foams obtained can be used for thermal insulation, for example in refrigeration appliances, for the insulation of pipes and for the production of composite elements, known as sandwich elements.

The process of the invention makes it possible to utilize, in particular, the excellent solubility of sucrose in water to force the reaction of the sucrose in the initial phase of the alkoxylation of sucrose-comprising starter mixtures. As the reaction of the sucrose with propylene oxide proceeds, the solubility of these propoxylates in water decreases very rapidly, so that further sucrose can be dissolved and in turn propoxylated.

To minimize the glycol formation due to reaction with water, which proceeds in parallel, the water content can be reduced after formation of a prepolymer having a low degree of alkoxylation so that glycol formation is restricted during the further course of the alkoxylation. The amount of water in the stages of the process of the invention has to be matched to the starter mixture and the hydroxyl number which is to be achieved at the end. The water can also, as indicated above, be added in the form of an aqueous alkali metal hydroxide solution.

The reduction in the functionality is restricted and the occurrence of undissolved sucrose in the polyether alcohol is strongly suppressed, even virtually avoided under appropriate reaction conditions, by means of the process of the invention.

Clear, readily processable polyether alcohols whose starter mixtures comprise sucrose and hydroxyl-comprising liquid costarters and have mathematical functionalities of up to 7.25 and thus make it possible to build up a high network density in the rigid foam can be made available by means of the process of the invention.

The invention is illustrated by the following examples.

### EXAMPLE 1 (COMPARATIVE EXAMPLE)

17.3 kg of glycerol were placed in a 250 l pressure autoclave provided with a multistage agitator (250 rpm), reactor heating and cooling, metering facilities for solid and liquid substances and alkylene oxides and also facilities for blanketing with nitrogen and a vacuum system and were heated to 90° C. 0.947 kg of 48% strength aqueous potassium hydroxide solution and 57.0 kg of sucrose were then added and mixed in. The temperature of the mixture was increased to 108° C. and the water content was reduced to <0.1% by weight by stripping under reduced pressure. 51.4 kg of propylene oxide were subsequently metered in, with a pressure of 6.5 bar not being exceeded. The reaction temperature rose to 112° C. during the reaction and was maintained for the entire reaction time. The alkaline propoxylate obtained in this way had the following properties:

| Hydroxyl number | 778 mg KOH/g |
|---|---|
| Water content | 0.114% |

The sample of the product had a crystalline precipitate.

The prepolymer was reacted with a further 112.8 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| | | |
|---|---|---|
| Hydroxyl number: | 442 | mg KOH/g |
| Acid number | 0.014 | mg KOH/g |
| Water content | 0.036% | by weight |
| Viscosity at 25° C. | 19780 | mPa s |
| Content of free sucrose | 1.672% | by weight |

The sample of the product had a crystalline precipitate.

### EXAMPLE 2 (COMPARATIVE EXAMPLE)

14.13 kg of diethylene glycol were placed in a pressure autoclave equipped in an analogous fashion to that in comparative example 1 and were heated to 90° C. 0.898 kg of 48% strength aqueous potassium hydroxide solution and 57.0 kg of sucrose were then added and mixed in. The temperature of the mixture was increased to 108° C. 45.0 kg of propylene oxide were subsequently metered in, with a pressure of 6.5 bar not being exceeded. The reaction temperature rose to 112° C. during the reaction and was maintained for the entire reaction time. The alkaline propoxylate obtained in this way had the following properties:

| Hydroxyl number | 717 mg KOH/g |
|---|---|
| Water content | 0.171% |

The sample of the product had a crystalline precipitate.

The prepolymer was reacted with a further 83.3 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 5.33 | |
|---|---|---|
| Hydroxyl number: | 446 | mg KOH/g |
| Acid number | 0.037 | mg KOH/g |
| Water content | 0.031% | by weight |
| Viscosity at 25° C. | 18120 | mPa s |
| Content of free sucrose | 0.593% | by weight |

The product had a crystalline precipitate.

### EXAMPLE 3 (ACCORDING TO THE INVENTION)

14.65 kg of glycerol were placed in a pressure autoclave equipped in an analogous fashion to that in comparative example 1 and were heated to 90° C. 0.898 kg of 48% strength aqueous potassium hydroxide solution, 0.178 kg of water and 48.25 kg of sucrose were then added and mixed in. The temperature of the mixture was increased to 108° C. 42.9 kg of propylene oxide were subsequently metered in, with a pressure of 6.5 bar not being exceeded. The reaction temperature rose to 112° C. during the reaction and was maintained for the entire reaction time. The alkaline propoxylate obtained in this way had the following properties:

| Hydroxyl number | 772 mg KOH/g |
|---|---|
| Water content | 0.882% |

The sample of the product had no crystalline precipitate.

The prepolymer was reacted with a further 94.5 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 5.33 | |
|---|---|---|
| Hydroxyl number: | 445 | mg KOH/g |
| Acid number | 0.002 | mg KOH/g |
| Water content | 0.026% | by weight |
| Viscosity at 25° C. | 19155 | mPa s |
| Content of free sucrose | 0.052% | by weight |

The product was clear.

### EXAMPLE 4 (ACCORDING TO THE INVENTION)

14.13 kg of diethylene glycol were placed in a pressure autoclave equipped in an analogous fashion to that in comparative example 1 and were heated to 90° C. 0.898 kg of 48% strength aqueous potassium hydroxide solution, 0.545 kg of water and 57.0 kg of sucrose were then added and mixed in. The temperature of the mixture was increased to 108° C. 45.0 kg of propylene oxide were subsequently metered in, with a pressure of 6.5 bar not being exceeded. The reaction temperature rose to 112° C. during the reaction and was maintained for the entire reaction time. The alkaline propoxylate obtained in this way had the following properties:

| Hydroxyl number | 710 mg KOH/g |
|---|---|
| Water content | 0.933% |

The sample of the product had no crystalline precipitate.

The prepolymer was reacted with a further 85.3 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 5.33 | |
|---|---|---|
| Hydroxyl number: | 454 | mg KOH/g |
| Acid number | 0.032 | mg KOH/g |
| Water content | 0.038% | by weight |
| Viscosity at 25° C. | 18845 | mPa s |
| Content of free sucrose | 0.087% | by weight |

The product was free of solid residues.

### EXAMPLE 5 (ACCORDING TO THE INVENTION)

9.25 kg of diethylene glycol were placed in a pressure autoclave equipped in an analogous fashion to that in comparative example 1 and were heated to 90° C. 0.898 kg of 48% strength aqueous potassium hydroxide solution, 2.956 kg of water and 59.74 kg of sucrose were then added and mixed in. The temperature of the mixture was increased to 108° C. 48.0 kg of propylene oxide were subsequently metered in, with a pressure of 6.5 bar not being exceeded. The reaction temperature rose to 112° C. during the reaction and was maintained for the entire reaction time. The product was subsequently dried to a water content of 1% by weight by vacuum stripping. The alkaline propoxylate obtained in this way had the following properties:

| Hydroxyl number | 715 mg KOH/g |
|---|---|
| Water content | 1.060% |

The sample of the product had no crystalline precipitate.

The prepolymer was reacted with a further 88.0 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 6.0 | |
|---|---|---|
| Hydroxyl number: | 442 | mg KOH/g |
| Acid number | 0.008 | mg KOH/g |
| Water content | 0.054% | by weight |
| Viscosity at 25° C. | 28760 | mPa s |
| Content of free sucrose | 0.071% | by weight |

The product was completely clear.

### EXAMPLE 6 (ACCORDING TO THE INVENTION)

8.57 kg of glycerol were placed in a pressure autoclave equipped in an analogous fashion to that in comparative example 1 and were heated to 90° C. 0.898 kg of 48% strength aqueous potassium hydroxide solution, 2.85 kg of water and 58.02 kg of sucrose were then added and mixed in. The temperature of the mixture was increased to 108° C. 46.0 kg of propylene oxide were subsequently metered in, with a pressure of 6.5 bar not being exceeded. The reaction temperature rose to 112° C. during the reaction and was maintained for the entire reaction time. The product was subsequently dried to a water content of 1% by weight by vacuum stripping. The alkaline propoxylate obtained in this way had the following properties:

| Hydroxyl number | 741 mg KOH/g |
|---|---|
| Water content | 1.064% |

The sample of the product had no crystalline precipitate.

The prepolymer was reacted with a further 91.0 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 6.23 | |
|---|---|---|
| Hydroxyl number: | 459 | mg KOH/g |
| Acid number | 0.015 | mg KOH/g |
| Water content | 0.032% | by weight |
| Viscosity at 25° C. | 44443 | mPa s |
| Content of free sucrose | 0.01 | % by weight |

The product was completely clear.

### EXAMPLE 7 (ACCORDING TO THE INVENTION)

3.07 kg of glycerol were placed in a pressure autoclave equipped in an analogous fashion to that in comparative example 1 and were heated to 90° C. 0.898 kg of 48% strength aqueous potassium hydroxide solution, 2.70 kg of water and 57.0 kg of sucrose were then added and mixed in. The temperature of the mixture was increased to 108° C. 48.0 kg of propylene oxide were subsequently metered in, with a pressure of 6.5 bar not being exceeded. The reaction temperature rose to 112° C. during the reaction and was maintained for the entire reaction time. The product was subsequently dried to a water content of 1% by weight by vacuum stripping. The alkaline propoxylate obtained in this way had the following properties:

| Hydroxyl number | 705 mg KOH/g |
|---|---|
| Water content | 1.068% |

The sample of the product had no crystalline precipitate.

The prepolymer was reacted with a further 106.2 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 7.17 | |
|---|---|---|
| Hydroxyl number: | 406 | mg KOH/g |
| Acid number | 0.021 | mg KOH/g |
| Water content | 0.050% | by weight |
| Viscosity at 25° C. | 25519 | mPa s |
| Content of free sucrose | 0.04% | by weight |

The product was completely clear.

### EXAMPLE 8 (ACCORDING TO THE INVENTION)

5.71 kg of glycerol were placed in a pressure autoclave equipped in an analogous fashion to that in comparative example 1 and were heated to 90° C. 0.898 kg of 48% strength aqueous potassium hydroxide solution, 2.70 kg of water and 53.01 kg of sucrose were then added and mixed in. The temperature of the mixture was increased to 108° C. 48.0 kg of propylene oxide were subsequently metered in, with a pressure of 6.5 bar not being exceeded. The reaction temperature rose to 112° C. during the reaction and was maintained for the entire reaction time. The product was subsequently dried to a water content of 0.5% by weight by vacuum stripping. The alkaline propoxylate obtained in this way had the following properties:

| Hydroxyl number | 685 mg KOH/g |
|---|---|
| Water content | 0.487% |

The sample of the product had no crystalline precipitate.

The prepolymer was reacted with a further 96.0 kg of propylene oxide at 112° C. and 6.5 bar.

This was followed by an after-reaction time of 3 hours at 115° C. The crude polyether alcohol obtained was hydrolyzed with water, neutralized with phosphoric acid, filtered and vacuum stripped.

The end product had the following properties:

| Calculated functionality: | 6.57 | |
|---|---|---|
| Hydroxyl number: | 404 | mg KOH/g |
| Acid number | 0.035 | mg KOH/g |
| Water content | 0.040% | by weight |
| Viscosity at 25° C. | 21412 | mPa s |
| Content of free sucrose | 0.021% | by weight |

The product was completely clear.

The determination of the hydroxyl number was carried out in accordance with DIN 53420, the determination of the acid number was carried out in accordance with DIN EN ISO 2114, the determination of the viscosity was carried out in accordance with DIN 53019 and the determination of the water content was carried out in accordance with DIN 51777.

The determination of the free sucrose was carried out by the test method PFO/A 00/23-116. For this purpose, 200 mg of the polyether alcohol were dissolved by means of 200 microliters of a solution of 2 mg of 1-dodecanol in 1 ml of pyridine and then admixed with 600 microliters of N-methyl-N-trimethylsilyltrifluoroacetamide (MSTFA). After addition of the MSTFA, the sample was heated at 70-80° C. for 2 hours in an oven. The sample was cooled to room temperature and then injected into the gas chromatograph.

1. A process for preparing polyether alcohols by catalytic addition of alkylene oxides onto a starter substance mixture comprising water-soluble H-functional starter substances which are solid at room temperature, alcohols which are liquid at the reaction temperature and water using alkali metal hydroxides and/or alkaline earth metal hydroxides as catalysts, wherein the amount of water is from 1.0 to 6.0% by weight, based on the weight of the starter substance mixture, and the starter substance mixture comprises no amine constituents and the water content of the reaction mixture is reduced to less than 1% by weight, based on the weight of the starter substance mixture, after addition of from 2 to 6 mol of alkylene oxide onto the starter substance mixture.

2. The process according to claim 1, wherein the water-soluble H-functional starter substance which is solid at room temperature is selected from the group consisting of sucrose and/or sorbitol.

3. The process according to claim 1, wherein the amount of water is from 1.0 to 3.5% by weight, based on the weight of the starter substance mixture.

4. The process according to claim 1, wherein the functionality of the starter substance mixture without taking the water into account is greater than 4.5.

5. The process according to claim 1, wherein the hydroxyl number of the polyether alcohols is in the range from 300 to 600 mg KOH/g.

6. The process according to claim 1, wherein the alcohols which are liquid at the reaction temperature are one or more alcohols selected from the group consisting of glycerol, trimethylolpropane, ethylene glycol, diethylene glycol, triethylene glycol, propylene glycol, dipropylene glycol, tripropylene glycol and butanediols.

7. The process according to claim 4, wherein the alcohols which are liquid at the reaction temperature are one or more alcohols selected from the group consisting of glycerol and trimethylolpropane.

8. A polyether alcohol produced by the process according to claim 1.
